(19) United States
(12) Patent Application Publication
(10) Pub. No.: US 2014/0023933 A1
(43) Pub. Date: Jan. 23, 2014

(54) NON-AQUEOUS ELECTROLYTE SECONDARY BATTERY, AND PROCESS FOR PRODUCING SAME

(71) Applicants: Takanobu Chiga, Osaka (JP); Naoki Imachi, Hyogo (JP); Jun Teramoto, Kanagawa (JP); Yasushi Inda, Kanagawa (JP)

(72) Inventors: Takanobu Chiga, Osaka (JP); Naoki Imachi, Hyogo (JP); Jun Teramoto, Kanagawa (JP); Yasushi Inda, Kanagawa (JP)

(73) Assignees: OHARA INC., Sagamihara-shi, Kanagawa (JP); SANYO ELECTRIC CO., LTD., Moriguchi-shi, Osaka (JP)

(21) Appl. No.: 14/007,608

(22) PCT Filed: Mar. 15, 2012
(86) PCT No.: PCT/JP2012/056700

§ 371 Date: Sep. 25, 2013

(30) Foreign Application Priority Data
Mar. 30, 2011 (JP) 2011-075369

(51) Int. Cl. H01M 10/0562; H01M 10/0525

(52) U.S. Cl. CPC H01M 10/0562; H01M 10/0525
USPC 429/319

(57) ABSTRACT

Provided are a non-aqueous electrolyte secondary battery having excellent high-temperature durability and capable of reducing the initial percent defective and a process for producing the same. The non-aqueous electrolyte secondary battery includes: a positive electrode containing a positive-electrode active material; negative electrode containing a negative-electrode active material; a non-aqueous electrolyte; and a porous layer provided on a surface of the positive electrode, wherein the porous layer contains inorganic solid electrolyte particles having a crystalline structure of rhombohedral crystal (R3c) with lithium ion conductivity represented by Li_{1+x+y}AlₓTi₂₋ₓSi_{y}P_{3-y}O₁₂ (where 0≦x≦1 and 0≦y≦1) and an aqueous binder.

### TECHNICAL FIELD

This invention relates to non-aqueous electrolyte secondary batteries with a porous layer formed on a surface of a positive electrode and processes for producing the same.

### BACKGROUND ART

In recent years, mobile information terminals, such as cellular phones, notebook computers, and PDAs, have enhanced their features, such as a video playback feature and a gaming feature, and have thereby tended to increase their power consumption. Therefore, lithium ion secondary batteries serving as their driving power sources are being strongly required to achieve a still higher capacity and higher performance, such as a longer playback time or an improved power output.

In relation to the capacity increase of a lithium ion secondary battery, it has been considered to charge the positive-electrode active material with a high voltage. This however, involves some improvements, such as prevention of the attendant oxidation of the electrolytic solution and control of the activity of the positive-electrode active material.

Patent Literature 1 describes that a porous layer made of inorganic particles, such as titania, is formed on the surface of the positive electrode, whereby the battery performance can be improved under high voltage and high temperature conditions.

Patent Literature 2 describes that a porous layer is formed on the negative electrode using a solvent-based slurry containing inorganic particles, whereby the insulation property is increased and the battery safety is improved. This literature also describes that the inorganic particles are preferably made of inorganic oxides, particularly preferably made of alumina or titania.

Patent Literatures 3 and 4 describe that the positive electrode or the negative electrode contains a lithium-ion conductive, inorganic solid electrolyte, whereby the cycle characteristics at high temperatures are improved.

### CITATION LIST

### Patent Literature

Patent Literature 1: WO2007/108425
Patent Literature 2: WO2005/029614
Patent Literature 3: JP-A 2008-117542
Patent Literature 4: JP-A 2003-117543

### SUMMARY OF INVENTION

### Technical Problem

With the use of a porous layer disclosed in Patent Literatures 1 and 2, the high-temperature durability can be improved but is not sufficiently effective. Therefore, it is desired to further improve the high-temperature durability. In addition, the inventors have found from various studies that the formation of a porous layer using inorganic particles, such as alumina or titanic, causes a problem in that the initial percent defective of the resultant battery is high.

The inventors have conducted intensive studies on why the initial percent defective is high when a conventional porous layer using inorganic particles, such as alumina or titania, is provided on the surface of the positive electrode. The results of the studies are described just below. In preparing an aqueous slurry containing inorganic particles and an aqueous binder for the purpose of forming a porous layer, the inorganic particles are dispersed by means of a disperser in order to disperse the inorganic particles. If in this case a metal, such as SUS, is used in the surface of the container of the disperser, the surface of the disperser container is abraded by the inorganic particles, so that metal components, such as an SUS component, are incorporated as impurities into the porous layer. Because a potential of about 4 V is applied to these impurities in the vicinity of the positive electrode, metal ion components, such as Fe ions, will be reduced on the negative electrode and precipitate thereon as metal components. Hence, a short circuit will occur between the positive and negative electrodes and thus the initial percent defective will be high. To cope with this, there is an attempt of improvement in terms of apparatus, such as application of a ceramic coating on the surface of the disperser container. However, this leads to high cost. Accordingly, there is a need to develop inorganic particles having lower hardness.

In Patent Literatures 3 and 4, a lithium-ion conductive, inorganic solid electrolyte, is contained in the positive electrode or the negative electrode. However, these methods are not enough to achieve high-temperature durability, particularly, reduce the battery degradation under continuous charging at high temperatures.

An object of the present invention is to provide a non-aqueous electrolyte secondary battery having excellent high-temperature durability and capable of reducing the initial percent detective and a process for producing the same.

### Solution to Problem

A non-aqueous electrolyte secondary battery of the present invention is a non-aqueous electrolyte secondary battery including: a positive electrode containing a positive-electrode active material; a negative electrode containing a negative-electrode active material; a non-aqueous electrolyte; and a porous layer provided on a surface of the positive electrode, wherein the porous layer contains inorganic solid electrolyte particles of lithium-ion conductivity having a crystal structure of rhombohedral crystal (R3c) represented by Li_{1+x+y}AlₓTi₂₋ₓSi_{y}P_{3-y}O₁₂ (where 0≦x≦1 and 0≦y≦1) and an aqueous binder.

In the present invention, a non-aqueous electrolyte secondary battery can be provided which has excellent high-temperature durability and can reduce the initial percent defective.

In the present invention, inorganic solid electrolyte particles of lithium-ion conductivity having a crystal structure of rhombohedral crystal (R3c) represented by Li_{1+x+y}AlₓTi₂₋ₓSi_{y}P_{3-y}O₁₂ (where and are used as the inorganic particles contained in the porous layer. The inorganic solid electrolyte particles of this type have a lower hardness than alumina and titania. Therefore, when a porous layer is formed using the inorganic solid electrolyte particles of the present invention, impurity incorporation from the disperser due to abrasion of the disperser container can be significantly reduced. Hence, the incorporation of impurities, such as Fe, can be reduced to prevent the attendant short circuit between the positive and negative electrodes and like problems, which enables significant reduction in initial percent defective.

The inorganic, solid electrolyte particles of the present invention may only have to have a crystal structure of a rhombohedral crystal (R3c) represented by Li_{1+x+y}AlₓTi₂₋ₓSi_{y}P_{3-y}O₁₂ (where 0≦x≦1 and 0≦y≦1). For example, Li, Al, Ti, Si, F, and O atoms constituting the crystal structure may be partly substituted with one or more other elements. So long as the inorganic solid electrolyte particles have the above crystal structure, their characteristics do not significantly vary. For example, if trivalent elements, Y and Ga, are added to the inorganic solid electrolyte of the present invention, the sites of Ti will be partly substituted with these elements. Since, however, the crystal structure is not changed, even the inorganic solid electrolyte particles with the sites of Ti partly substituted can achieve the same characteristics and effects as those with no element site substituted. The above crystal structure of a rhombohedral crystal (RSc) is commonly called as a NASICON structure.

The mother grass of the inorganic solid electrolyte particles of the present invention has a Li₂O—Al₂O₃—TiO₂—SiO₂—P₂O₅-based composition. By subjecting the mother glass to a thermal treatment to crystallize it, a crystal structure of Li_{1+x+y}AlₓTi₂₋ₓSi_{y}P_{3-y}O₁₂ (where 0≦x≦1 and 0≦y≦1) can be obtained. Then, the inorganic solid electrolyte obtained by the crystallization is crushed in a dry ball mill and then ground in a wet ball mill, so that inorganic solid electrolyte particles of the present invention can be obtained.

LiTi₂P₃O₁₂, which can be obtained by simply mixing and firing source materials, has poor water resistance and is therefore difficult to make into an aqueous slurry. However, an inorganic solid electrolyte having a crystal structure of Li_{1+x+y}AlₓTi₂₋ₓSi_{y}P_{3-y}O₁₂ (where 0≦x≦1 and 0≦y≦1) which is synthesized by adding Al and Si to LiTiP₃O₁₂ and subjecting the mixture to vitrification and crystallization processes, has water resistance and therefore has favorable characteristics as a filler for the porous layer.

The chemical composition of the aforementioned mother glass is preferably within the following range in mol % of oxide component.

P₂O₅: 26 to 40%,

SiO₂: 0.5 to 12%,

TiO₂: 30 to 45%,

Al₂O₃: 5 to 10%, and

Li₂O: 10 to 18%.

The average particle size of inorganic solid electrolyte particles in the present invention is preferably up to 1 μm and more preferably within a range of 0.01 to 0.8 μm. As the average particle size of the inorganic solid electrolyte particles decreases, the surface area of the inorganic solid electrolyte may increase to increase the cohesive force, resulting in difficulty in dispersing the inorganic solid electrolyte particles. On the other hand, as the average particle size of the inorganic solid electrolyte particles increases, the porous layer will be thicker, which may result in degraded load characteristic or reduced energy density of the resultant battery.

In the present invention, an aqueous binder is used as the binder for the porous layer. Therefore, the porous layer can be formed using a slurry containing water as a dispersion medium. Generally, in a positive-electrode active material layer, a binder containing N-methyl-2-pyrrolidone (NMP) or the like as a solvent is used. Therefore, in the case of use of not water but a solvent also in forming a porous layer on the surface of the positive electrode, upon coating of the porous layer on the surface of the positive electrode, the solvent and the binder will be highly likely to penetrate inside, of the active material layer to cause the binder in the active material layer to swell. Since in the present invention an aqueous binder is used, the porous layer can be formed by an aqueous slurry. Therefore, without damage to the positive-electrode active material layer, a non-aqueous electrolyte, secondary battery having excellent high-temperature durability can be produced.

Although no limitation is placed on the aqueous binder in the porous layer, particularly on its material, it should preferably satisfy comprehensively the following properties (1) to (4) (1) reliable dispersibility of the filler (prevention of reaggregation thereof), (2) reliable adhesion that can withstand the battery production process, (3) filling in filler spaces due to swelling after the absorption of the non-aqueous electrolyte, and (4) less elution into the non-aqueous electrolyte. In order to ensure the battery performance, these effects should preferably be exerted at a small amount of binder. Therefore, the amount of aqueous binder in the porous layer is preferably up to 30 parts by mass, more preferably up to 10 parts by mass, and still more preferably up to 5 parts by mass per 100 parts by mass of the inorganic solid electrolyte particles. The lower limit of the amount of aqueous binder in the porous layer is generally 0.1 parts by mass or more. Examples of preferred materials of the aqueous binder to be used include polytetrafluoroethylene (PTFE), polyacrylonitrile (PAN), styrene-butadiene rubber (SBR), their modified products and derivatives, copolymers containing acrylonitrile units, and polyacrylic acid derivatives. Particularly, in the case of emphasizing the properties (1) and (3) copolymers containing acrylonitrile units are preferably used.

The aqueous binder in the present invention can be used, for example, in the form of emulsion resin or water-soluble resin.

The thickness of the porous layer is preferably up to 5 μm, more preferably within the range of 0.2 to 4 μm, and particularly preferably within the range of 1 to 3 μm. If the thickness of the porous layer is too small, the effects obtained by forming the porous layer may be insufficient. If the thickness of the porous layer is too large, this may result in degraded load characteristic or reduced energy density of the resultant battery.

A product ion process of the present invention is a process capable of producing the above non-aqueous electrolyte secondary battery of the present invention and the process includes the steps of: producing the positive electrode; preparing an aqueous slurry containing the inorganic solid electrolyte particles and the aqueous binder; forming the porous layer on a surface of the positive electrode by applying the aqueous slurry on the surface of the positive electrode; and producing a non-aqueous electrolyte secondary battery using the positive electrode with the porous layer formed thereon, the negative electrode, and the non-aqueous electrolyte.

In the production process of the present invention, a non-aqueous electrolyte secondary battery can be efficiently produced which has excellent high-temperature durability and can reduce the initial percent defective.

In the production process of the present invention, even if the inorganic solid electrolyte particles in the aqueous slurry are subjected to a dispersion treatment using a disperser with a metallic container, i.e., a disperser in which a portion thereof to be in contact with the aqueous slurry is made of metal, the amount of impurities incorporated into the aqueous slurry by the dispersion treatment can be reduced. Therefore, the initial percent defective due to impurities can be reduced.

Examples of a method for forming the porous layer on a surface of the positive electrode include die coating, gravure coating, dip coating, curtain coating, and spray coating. Among them, gravure coating or die coating is preferably used. Considering reduction in adhesive strength or other effects due to diffusion of the solvent and binder into the inside of the electrode, a method capable of coating at high speed and providing a short drying time is preferred. In the case of spray coating, dip coating or curtain coating, which have, difficulty mechanically controlling the thickness, the solid content concentration in the slurry is preferably low, for example, preferably within the range of 3 to 30% by mass. On the other hand, in the case of die coating, gravure coating or the like, the solid content concentration in the slurry may be high and is preferably about 5% to about 70% by mass.

A non-aqueous electrolyte secondary battery is produced using the positive electrode with the porous layer formed thereon in the above manner, the negative electrode, and the non-aqueous electrolyte.

During charging and discharging of the non-aqueous electrolyte secondary battery, the electrolytic solution decomposed on the positive electrode, the metal ions eluted from the positive electrode, and so on are trapped by the porous layer provided on the positive electrode. Thus, clogging of a separator provided between the positive and negative electrodes and precipitation of metal ions and the like on the negative electrode can be reduced. Therefore, the porous layer can exert its filtering function to improve the high-temperature durability.

Furthermore, since the porous layer is provided between the separator and the positive electrode, the separator and the positive-electrode active material do not make physical contact with each other. Thus, the oxidation of the separator can be reduced.

Examples of the positive-electrode active material are materials having a layered structure. The particularly preferred material for use is a lithium-containing transition metal oxide having a layered structure. Examples of such a lithium-containing transition metal oxide are lithium composite oxides, including lithium cobaltate, Co—Ni—Mn-containing lithium composite oxide, Al—Ni—Mn-containing lithium composite oxide, and Al—Ni—Co-containing lithium composite oxide. The above positive-electrode active materials may be used alone or in a mixture of different ones of them.

No particular limitation is placed on the negative-electrode active material and any material can be used so long as it can be used as a negative-electrode active material for a non-aqueous electrolyte secondary battery. Examples of the negative-electrode active material include carbon materials, such as graphite and coke; metal oxides, such as tin oxide; metals that can form an alloy with lithium to store lithium, such as silicon and tin; and metal lithium.

The non-aqueous electrolyte secondary battery of the present invention is preferably charged so that the end-of-charge potential of the positive electrode reaches 4.30 V (vs. Li/Li⁺) or more, more preferably reaches 4.35 V (vs. Li/Li⁺) or more, and still more preferably reaches 4.40 V (vs. Li/Li⁺) or more. If a carbon material is used as the negative-electrode active material, the end-of-charge potential of the negative electrode will be approximately 0.1 V (vs. Li/Li⁺). Therefore, when the end-of-charge potential of the positive electrode is 4.30 V (vs. Li/Li⁺), the resultant end-of-charge voltage will be 4.20 V. When the end-of-charge potential of the positive electrode is 4.40 V (vs. Li/Li⁺), the resultant end-of-charge voltage will be 4.30 V. When in this manner the battery is charged so that the end-of-charge potential of the positive electrode is higher than in conventional cases, the charge/discharge capacity can be increased.

When the end-of-charge potential of the positive electrode is increased, a transition metal, such as Co or Mn, may be likely to be eluted from the positive-electrode active material. However, the porous layer can prevent the eluted. Co or Mn from depositing on the negative electrode surface. Therefore, the degradation in high-temperature shelf life characteristic resulting from deposition of Co or Mn on the negative, electrode surface can be reduced to increase the high-temperature durability.

Furthermore, the non-aqueous electrolyte secondary battery of the present invention has an excellent shelf life characteristic at high temperatures and can significantly exert the effect when used for example, as a non-aqueous electrolyte secondary battery placed in an operating environment at 50° C. or above.

Usable solvents for the non-aqueous electrolyte are any solvents conventionally used as a solvent for an electrolyte in a lithium secondary battery. Among them, particularly preferred solvents for use are mixture solvents of a cyclic carbonate and a chain carbonate. Specifically, it is preferred that the mixture ratio between the cyclic carbonate and the chain carbonate (cyclic carbonate to chain carbonate) be within the range of 1:9 to 5:5 by volume. Examples of the cyclic carbonate include ethylene carbonate, propylene carbonate, butylene carbonate, and vinylene carbonate. Examples of the chain carbonate include dimethyl carbonate, methyl ethyl carbonate, and diethyl carbonate.

Examples of usable solutes for the non-aqueous electrolyte include LiPF₆, LiBF₄, LiCF₃SO₃, LiN(CF₃SO₂)₂, LiN(C₂F₅SO₂)₂, LiC(CF₃SO₂)₃, LiC(C₂F₅SO₂)₃, and mixtures thereof.

Examples of electrolytes that may be used include gel polymer electrolytes in which a polymer electrolyte, such as polyethylene oxide or polyacrylonitrile, is impregnated with an electrolytic solution, and inorganic solid electrolytes, such as LiI and Li₃N.

No particular limitation is placed on the usable electrolyte for the non-aqueous electrolyte secondary battery so long as the lithium compound as a solute for developing ion conductivity and the solvent for dissolving and retaining the lithium compound therein are not decomposed by application of voltage during battery charging and discharging or battery storage.

Usable separators to be disposed between the porous layer provided on the positive electrode and the negative electrode are any separators conventionally used as a separator for a non-aqueous electrolyte secondary battery. For example, a microporous membrane made of polyethylene or polypropylene can be used.

The ratio of the charge capacity of the negative electrode to the charge capacity of the positive electrode (negative electrode charge capacity to positive electrode charge capacity) is preferably within the range of 1.0 to 1.1. By setting the positive electrode, to negative electrode charge capacity ratio at 1.0 or more, it can be prevented that metal lithium precipitates on the surface of the negative electrode. Therefore, the cycle characteristics and safety of the battery can be improved. On the other hand, if the positive electrode to negative electrode charge capacity ratio exceeds 1.1, the energy density per volume may decrease, which is unfavorable. The above positive electrode to negative electrode charge capacity ratio is set depending on the end-of-charge voltage of the battery.

### Advantageous Effects of Invention

In the present invention, a non-aqueous electrolyte secondary battery can be provided which has excellent high-temperature durability and can reduce the initial percent defective.

### DESCRIPTION OF EMBODIMENTS

Hereinafter, the present invention will be described in more detail with reference to specific examples. However, the present invention is not limited at all by the following examples and can be embodied in various other forms appropriately modified without changing the spirit of the invention.

### Examples 1 and 2 and Comparative Examples 1 to 4

### Example 1

### Production of Positive Electrode

Lithium cobaltate was used as a positive-electrode active material. Lithium cobaltate, acetylene black serving as a conductive carbon material, and PVDF (poly(vinylidene fluoride) were mixed in a mass ratio of 95:2.5:2.5 into NMP serving as a solvent with a kneader to prepare a slurry for a positive electrode mixture.

The prepared slurry was applied on both sides of a piece of aluminum foil, then dried and rolled to produce a positive electrode. The packing density in the positive electrode was 3.80 g/cm³.

[Production of Inorganic Solid Electrolyte Particles]

H₃PO₄, Al (PO₃)₃, Li₂CO₃, SiO₂, and TiO₂ were used as source materials. These materials were weighed to give, in mol % of oxide, 35.0% P₂O₅, 7.5% Al₂O₃, 15.0% Li₂O, 38.0% TiO₁, and 4.5% SiO₂ and homogeneously mixed. The resultant mixture was put into a platinum pot and melted by heating with stirring in an electric furnace at 1500° C. for three hours to obtain a glass melt. Thereafter, the glass melt was cast into running water to obtain glass flakes. The glass flakes were crystallized by a thermal treatment at 950° C. for 12 hours to obtain desired glass ceramics. The precipitated crystal phase was confirmed, by powder X-ray diffractometry, to include as a principal crystal phase Li_{1+x+y}AlₓTi₂₋ₓSi_{y}P_{3-y}O₁₂ (where 0≦x≦1 and 0≦y≦1).

The glass ceramics were ground by a dry ball mill to obtain powder having an average particle size of 2 μm. Using ethanol as a dispersion medium, the powder having an average particle size of 2 μm was further ground by a ball mill to prepare inorganic solid electrolyte particles having an average particle size of 400 nm.

[Formation of Porous Layer]

An aqueous slurry t1 was prepared using water as a dispersion medium, the obtained inorganic solid electrolyte particles (having as a principal crystal Li_{1+x+y}AlₓTi₂₋ₓSi_{y}P_{3-y}O₁₂ (where 0≦x≦1 and 0≦y≦1) and an average particle size of 400 nm) as a filler, copolymer (rubber polymer) containing an acrylonitrile structure (unit) as an aqueous binder, and CMC (sodium carboxymethyl cellulose) as a dispersant. The solid content concentration of the filler in the aqueous slurry t1 was 20% by mass. The aqueous binder was used to give a concentration of 3 parts by mass per 100 parts by mass of the filler. CMC was used to give a concentration of 0.5 parts by mass per 100 parts by mass of the filler. The disperser used was “FILMIX” (with a container made of SUS) manufactured by PRIMIX Corporation. The aqueous slurry t1 was used to coat both sides of the positive electrode by gravure coating and water as the solvent was dried and removed, whereby porous layers were formed on both the surfaces of the positive electrode. The porous layers were formed so, that the thickness of each on each side was 1.5 μm and the total thickness on both sides was 3 μm.

[Production of Negative Electrode]

A carbon material (graphite) was used as a negative-electrode active material and the carbon material, CMC (sodium carboxymethyl cellulose), and SBR (styrene-butadiene rubber) were mixed together to prepare: a slurry for forming a negative-electrode mixture layer. The mass ratio of the negative-electrode active material to CMC to SBP was 98:1:1. The slurry for forming a negative electrode mixture layer was applied on both sides of a piece of copper foil, then dried and rolled to produce a negative electrode. The packing density of the negative-electrode active material was 1.60 g/cm³.

[Preparation of Non-Aqueous Electrolytic Solution]

Ethylene carbonate (EC) and diethyl carbonate (DEC) were mixed to give a volume ratio of 3:7. Added to the resultant mixture solvent was LiPF₆ to reach a concentration of 1 mol/L, thereby preparing a non-aqueous electrolytic solution.

[Assembly of Battery]

Lead terminals were attached to the above positive and negative electrodes. The positive electrode, and the negative electrode were disposed facing each other with a separator in between and these components were helically wound up together and pressed down in a flattened form to produce an electrode assembly. The electrode assembly was inserted into an aluminum laminate serving as battery outer package, the above non-aqueous electrolytic solution was then poured into the aluminum laminate, and the aluminum laminate was then sealed to produce a test battery. The design capacity of the battery was 800 mAh. The battery was designed to have an end-of-charge voltage of 4.4 V and designed so that the capacity ratio between positive, and negative electrodes (first charge capacity of negative electrode to first charge capacity of positive electrode) at 4.4 V was 1.05. The separator used was a microporous polyethylene membrane having an average pore diameter of 0.1 μm, a thickness of 16 μm, and a porosity rate of 47%.

The lithium secondary battery produced in the above manner is hereinafter referred to as a battery T1.

### Example 2

In the preparation of inorganic solid electrolyte particles as in Example 1, the conditions of the final ball-mill grinding using ethanol as a dispersion medium were changed to prepare inorganic solid electrolyte particles having an average particle size of 200 nm. An aqueous slurry t2 was prepared in the same manner as in Example 1 except for use of the above inorganic solid electrolyte particles and a battery T2 was produced in the same manner as in Example 1 except that porous layers were formed using the aqueous slurry t2.

### Comparative Example 1

A battery was produced in the same manner as in Example 1 except that no porous layer was formed on the surfaces of the positive electrode. This battery is hereinafter referred to as a comparative battery R1.

### Comparative Example 2

Lithium cobaltate the same inorganic solid electrolyte (having as a principal crystal Li_{1+x+y}AlₓTi₂₋ₓSi_{y}P_{3-y}O₁₂ (where 0≦x≦1 and 0≦y≦1) and an average particle size of 200 nm) as used in Example 2, acetylene black serving as a conductive carbon material, and PVDF (poly (vinylidene fluoride)) were mixed in a mass ratio of 94.05:0.95:2.5:2.5 into NMP serving as a solvent with a kneader to prepare a slurry for a positive electrode mixture.

The prepared slurry was applied on both sides of a piece of aluminum foil, then dried and rolled to produce a positive electrode. The packing density in the positive electrode was 3.80 g/cm³. Thereafter, a battery was produced in the same manner as in Comparative Example 1 without forming any porous layer. This battery is hereinafter referred to as a comparative battery R2. The total amount of inorganic solid electrolyte in the comparative battery R2 was approximately equal to that in Example 2.

### Comparative Example 3

An aqueous slurry r3 and a battery R3 were produced in the same manner as in Example 1 except for the use of alumina (Al₂O₃, high-purity alumina with an average particle size of 500 nm, manufactured by Sumitomo Chemical Co., Ltd. under the trade name “AKP 3000”) as a filler.

### Comparative Example 4

An aqueous slurry r4 and a battery R4 were produced in the same manner as in Example I except for the use of titania (TiO₂, high-purity rutile titania with an average particle size of 250 nm, manufactured by Ishihara Sangyo Kaisha, Ltd. under the trade name “CR-EL”) as a filler.

[Measurement of Impurities in Aqueous Slurry]

The aqueous slurries t1, t2, r3, and r4 were measured for impurities contained in each slurry. Specifically, 500 g of each aqueous slurry after the dispersion using the disperser and a magnet for impurity recovery were put into a covered polyethylene container and shaken with the container for an hour Thereafter, the magnet was recovered and rinsed in water and impurities attracted to the magnet were evaluated for size and composition using scanning electron microscopy (SEM) and energy dispersive X-ray analysis (EDX). Table 1 shows whether impurity particles with a diameter greater than 50 μm were present or not. Although the aqueous slurries before the dispersion using the disperser were also measured for impurities contained in each slurry, no impurity meeting the above criterion was collected because of the use of high-purity fillers.

TABLE 1

| Slurry | Impurities Collected by Magnet |
|---|---|
| t1 | none |
| t2 | none |
| r3 | present |
| r4 | present |

As shown in Table 1, impurity particles with a diameter greater than 50 μm were collected in the case of use of alumina or titania as a filler. When the composition of these impurity particles was evaluated by EDX it was found that the impurities were those containing Fe (Fe alone or SUS).

Since no impurities were collected from each aqueous slurry before the dispersion, it can be considered that the above impurities were incorporated during the dispersion. Furthermore, since, the impurities are those containing Fe, it is highly possible that the disperser container (made of SUS) was abraded by the aqueous slurries. Particularly, if water is used as a solvent, its lubrication effect is smaller than that of an organic solvent, so that the disperser will be likely to be damaged during dispersion of the filler. In the case where the porous layer formed on the surface of the positive electrode in the battery contains an impurity capable of dissolving at a high potential, when the positive electrode reaches or exceeds 4.0 V during charging, the impurity will be ionized, reduced at the negative electrode, and thus precipitate, resulting in ease of occurrence of internal short-circuit between the positive and negative electrodes. If an electrochemically stable, high-purity material, such as titania or alumina, is selected as a filler, the hardness of the particles tends to be high, so that the disperser will be very likely to be abraded. It can be considered that for these reasons the slurries r3 and r4 contained an increased amount of impurities with a diameter greater than 50 μm.

On the other hand, no impurity particles were collected in the cases of use of inorganic solid electrolyte particles as a filler. This can be attributed to a low hardness of the inorganic solid electrolyte particles. While the inorganic solid electrolyte particles have a Knoop hardness number of 590 Hk, general alumina particles have a Knoop hardness number of 2100 Hk and general titanic particles have a Knoop hardness number of 1200 Hk.

[Evaluation of Shelf Life Characteristic of Battery Under Continuous Charging]

The batteries T1 and T2 and the batteries R1 to R4 were evaluated for shelf life characteristic under continuous charging in the following manner.

Each battery was subjected to a single charge-discharge cycle test under the following conditions and then continuously charged again at 60° C. for 3 days without being cut off at a lower current limit. Thereafter, the battery was cooled down to room temperature and discharged at a rate of 1 It and the remaining capacity rate was calculated from the following equation.

Remaining capacity rate (%)={(discharge capacity after test)/(discharge capacity before test)}×100

Charge Conditions:

Each battery was charged to 4.4 V at a constant current of 1 It (800 mA) and the charged to a current of 1/20 It (37 mA) at a constant voltage of 4.4 V.

Discharge Conditions:

Each battery was discharged to 2.75 V at a constant current of 1 It (800 mA)

Pause:

A 10-minute pause was introduced between the above charging and discharging.

The shelf life characteristic (remaining capacity rates) of the batteries at 60° C. are shown in Table 2. Table 2 also shows initial percent defectives evaluated based on the criterion below.

[Initial Percent Defective]

Thirty samples for each battery were produced and the initial percent defective of the thirty samples was evaluated based on the following criterion.

Initial percent defective (%)={(the number of battery samples having an initial charge/discharge efficiency of up to 80%)/(the number of evaluated battery samples i.e., 30))}×100

TABLE 2

| | | Presence/ | | Remaining |
|---|---|---|---|---|
| | Porous | Absence | Initial Percent | Capacity |
| Battery | Layer | of Impurities | Defective | Rate |
| T1 | present | absence | 0/30 0% | 89% |
| T2 | present | absence | 0/30 0% | 90% |
| R1 | absent | — | 0/30 0% | 77% |
| R2 | absent | — | 0/30 0% | 75% |
| R3 | present | presence | 10/30 33% | 87% |
| R4 | present | presence | 7/30 23% | 88% |

As clearly seen from the results shown in Table 2, the initial percent defectives of the batteries T1 and T2 drastically reduced as compared with the batteries R3 and R4, depending upon presence or absence of impurities shown in Table 1. Furthermore, the batteries T1 and T2 improved the remaining capacity rate over the batteries R3 and R4. The batteries T1 and T2 improved the remaining capacity rate over the battery R1 and therefore could preserve the effect of improving the above characteristic under continuous charging at high temperature exerted by the formation of the porous layer. Moreover, as shown by the battery R2, the above characteristic under continuous charging at high temperature was not improved even if inorganic solid electrolyte particles were added to the positive-electrode active material layer.

### Examples 3 and 4 and Comparative Examples 5 and 6

### Example 3

A mixture of LiCoO₂ (lithium cobaltate) and LiNi_{1/3}Co_{1/3}Mn_{1/3}O₂ in a mass ratio of 9:1 was used as a positive-electrode active material. The positive-electrode active acetylene black serving as a conductive, carbon material, and PVDF (poly(vinylidene fluoride) were mixed in a mass ratio of 95:2.5:2.5 into NMP serving as a solvent with a kneader to prepare a slurry for a positive, electrode mixture. An aqueous slurry t3 and a battery T3 were produced in the same manner as in Example 1 except for the above.

### Example 4

In the preparation of inorganic solid electrolyte particles, the temperature for the thermal treatment of glass flakes was 850° C. for 12 hours. An aqueous slurry t4 and a battery T4 were produced in the same manner as in Example 3 except that the glass flakes after the thermal treatment were ground to produce inorganic solid electrolyte particles with an average particle size of 300 nm and the inorganic solid electrolyte particles were used. The precipitated crystal phase was confirmed, by powder X-ray diffractometry, to include as a principal crystal phase Li_{1+x+y}AlₓTi₂₋ₓSi_{y}P_{3-y}O₁₂ (where 0≦x≦1 and 0≦y≦1).

### Comparative Example 5

In the preparation of inorganic solid electrolyte particles, glass flakes were ground without subjecting them to the thermal treatment. The average particle size of the inorganic solid electrolyte particles thus obtained was 600 nm. An aqueous slurry r5 and a battery T5 were produced in the same manner as in Example 3 except for the use of the above particles. When these particles were measured by powder X-ray diffractometry, no Li_{1+x+y}AlₓTi₂₋ₓSi_{y}P_{3-y}O₁₂ (where 0≦x≦1 and 0≦y≦1) was confirmed and the particles were amorphous.

### Comparative Example 6

An aqueous slurry r6 and a battery R6 were produced in the same manner as in Example 3 except for the use of alumina (Al2O3, high-purity alumina with an average particle size of 500 nm, manufactured by Sumitomo Chemical Co., Ltd. under the trade name “AKP 3000”) as a filler.

[Measurement of Impurities in Aqueous Slurry]

The aqueous slurries t3, t4, r5, and r6 were also evaluated for size and composition of impurities attracted to the magnet. Table 3 shows whether impurity particles with a diameter greater than 50 μm were present or not.

TABLE 3

| Slurry | Impurities Collected by Magnet |
|---|---|
| t3 | none |
| t4 | none |
| r5 | none |
| r6 | present |

[Evaluation of Shelf Life Characteristic of Battery Under Continuous Charging]

The batteries T3, T4, R5, and R6 were also evaluated, like the other batteries, for remaining capacity rate, which is a shelf life characteristic under continuous charging, and initial percent defective and the evaluation results are shown in Table 4.

TABLE 4

| | | Presence/ | | Remaining |
|---|---|---|---|---|
| | Porous | Absence | | Capacity |
| Battery | Layer | of impurities | Initial Percent Defective | Rate |
| T3 | present | absence | 0/30 0% | 79% |
| T4 | present | absence | 0/30 0% | 80% |
| R5 | present | absence | 0/30 0% | 74% |
| R6 | present | presence | 12/30 40% | 74% |

As clearly seen from the results shown in Table 4, the batteries T3 and T4 exhibited an initial percent defective of 0% because they contained no impurities.

The battery R5 exhibited a reduced initial percent defective but a lower remaining capacity rate than the batteries T3 and T4 subjected to the thermal treatment. This shows that the characteristic under continuous charging at high temperatures can be improved only when inorganic solid electrolyte particles produced by the thermal treatment and having a crystal structure represented by Li_{1+x+y}AlₓTi₂₋ₓSi_{y}P_{3-y}O₁₂ (where 0≦x≦1 and and 0≦y≦1) are used as a filler for the porous layer.

As can be seen from the above, in the present invention, in the process of preparing an aqueous slurry for forming a porous layer, impurity incorporation due to abrasion of the disperser can be significantly reduced. This prevents the occurrence of defects due to small short-circuit between the positive and negative, electrodes in the interior of the battery. In addition, the effect of improving the shelf life characteristic at high temperatures owing to the formation of a porous layer can be preserved, which is effective in increasing the battery performance.

Also in the case of use of inorganic solid electrolyte particles of a crystal structure having a principal crystal phase of Li_{1+x+y}AlₓTi₂₋ₓSi_{y}P_{3-y}O₁₂ (where 0≦x≦1 and 0≦y≦1) but partly containing Y (yttrium) and Ga (gallium), the same effects as in Examples above can be obtained. The reason for this is that so long as the inorganic solid electrolyte particles have the above principal crystal phase, their characteristics do not significantly vary.

In order to produce inorganic solid electrolyte particles of a crystal structure having a principal crystal phase of Li_{1+x+y}AlₓTi₂₋ₓSi_{y}P_{3-y}O₁₂ (where 0≦x≦1 and 0≦y≦1) but partly containing Y (yttrium) and Ga (gallium), H₃PO₄, Al(PO₃)₃, Li₂CO₃, SiO₂, TiO₂, Y₂O₃, and Ga₂O₃, for example, are used as source materials. By using these source materials weighed to give a content of, in mol % of oxide, for example, 35.0% P₂O₅, 5.0% Al₂O₂, 15.0% Li₂O, 38.0% TiO₂, 4.5% SiO₂, 1.0% Y₂O₃, and 1.5% Ga₂O₃, inorganic solid electrolyte particles of a crystal structure having a principal crystal phase of Li_{1+x+y}AlₓTi₂₋ₓSi_{y}P_{3-y}O₁₂ (where 0≦x≦1 and 0≦y≦1) but partly containing Y (yttrium) and Ga (gallium) can be produced.

The non-aqueous electrolyte secondary battery of the present invention can be used as a driving power source, for example, for a mobile information terminal, such as a cellular phone, a notebook computer or a PDA. Alternatively, the non-aqueous electrolyte secondary battery of the present invention can be used in an HEV, an electric power tool or the like.

1. A non-aqueous electrolyte secondary battery comprising: a positive electrode containing a positive-electrode active material; a negative electrode containing a negative-electrode active material; a non-aqueous electrolyte; and a porous layer provided on a surface of the positive electrode,
wherein the porous layer contains inorganic solid electrolyte particles having a crystal structure of rhombohedral crystal (R3c) represented by Li_{1+x+y}AlₓTi₂₋ₓSi_{y}P_{3-y}O₁₂ (where 0≦x≦1 and 0≦y≦1) and an aqueous binder.

2. The non-aqueous electrolyte secondary battery according to claim 1, wherein the inorganic solid electrolyte particles have an average particle size of up to 1 μm.

3. The non-aqueous electrolyte secondary battery according to claim 1, wherein the inorganic solid electrolyte particles have lithium-ion conductivity.

4. (canceled)

5. (canceled)

6. The non-aqueous electrolyte secondary battery according to claim 2, wherein the inorganic solid electrolyte particles have lithium-ion conductivity.
